(19) United States
(12) Patent Application Publication
(10) Pub. No.: US 2012/0227298 A1
(43) Pub. Date: Sep. 13, 2012

(54) Sign Exhibiting Kit

(76) Inventor: Paula Alicea, Windsor Locks, CT (US)

(21) Appl. No.: 13/408,200

(22) Filed: Feb. 29, 2012

Related U.S. Application Data
(60) Provisional application No. 61/450,653, filed on Mar. 9, 2011.

(51) Int. Cl. G09F 15/00; G09F 7/00; G09F 15/02

(52) U.S. Cl. 40/610; 40/606.01

(57) ABSTRACT

A kit that readily enables a user create, decorate and exhibit a sign in order to display information or showcase a special occasion or event. The kit is comprised of, among other things, an easel, poster board or other media, a constructible frame, scissors, and decorative stickers, papers, charms and the like. The constructible frame further comprises mounting brackets for mounting the sign on a wall or other structure in conjunction with, or after, the special event or occasion.

### CROSS-REFERENCE

This application claims priority from Provisional Patent Application Ser. No. 61/450,653 filed on Mar. 9, 2012.

### FIELD OF THE INVENTION

This invention relates to a kit for creating, decorating and exhibiting a sign in order to display information or showcase an event.

### BACKGROUND

It is well known in the art to use easels with signage displayed thereon to display information or showcase an event. For example, easels with signs displayed thereon are often featured in hotels, convention centers and other gathering places to inform guests and participants about a particular program or event, or to convey a message of general interest. Easels with signs displayed thereon can also be used to commemorate a special event such as a birthday, anniversary, wedding or the like.

While these types of signs and exhibits are oftentimes an effective means of communication, the gathering of the materials necessary to prepare and display such exhibits can be time consuming and, therefore, frustrating for the party responsible for preparing the sign or exhibit. Further, not everyone can afford to have their sign or exhibit professionally prepared by a third party, which can be expensive and time-consuming.

Individuals preparing their own signs or exhibits must first gather all of the materials necessary to prepare the sign, such as posters, paper, numbers, letters, charms, and the like which, in and of itself, can be time-consuming because such items are oftentimes acquired from different sources and at differing times. Once the necessary materials have been gathered, the user must then prepare the actual sign or exhibit, and locate an easel or other device to exhibit said sign or exhibit upon. Moreover, because most signs and exhibits are a reflection of their maker, most sign makers want a sign that appears to have been professionally prepared. One way to improve the appearance of a sign or exhibit is to encompass the perimeter of the sign or exhibit with a decorative frame or border, or to use previously made themed decorations, charms and the like to decorate the sign or exhibit. Unfortunately, these materials are not oftentimes readily available for the sign maker, and the gathering of such individual materials can be both time consuming and expensive.

Consequently, there exists in the art a long-felt need for a self-contained kit that provides a user with all of the materials necessary to quickly and efficiently create, decorate and/or exhibit a sign in order to display information or showcase an event or special occasion in a professional manner. Additionally, there is a long-felt need for a self-contained kit that also enables the user to frame the sign or exhibit in a quick and cost effective manner, regardless of size. There is also a long felt need for a kit that enables a user to easily display the sign or exhibit on a wall or other structure after it is removed from the easel, or in lieu of being placed on a floor easel. Finally, there is a long-felt need for a kit that accomplishes all of the forgoing objectives and that is relatively easy and inexpensive to manufacture and use.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a self-contained kit that enables an individual to quickly and efficiently create, decorate and/or exhibit a sign in order to display information or showcase an event or special occasion in a professional manner. In one embodiment of the present invention, the sign exhibit kit comprises an easel, a constructible frame, a media, a pair of scissors, an adhesive such as glue, and at least one accessory for creating a sign such as self adhesive stickers, paper, letters, numbers, charms and/or themed decorations. In a preferred embodiment of the present invention, the constructible frame may further comprise mounting hardware for mounting the finished sign or exhibit on a wall or other structure after it has been removed from the easel, or in lieu of a floor easel.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a perspective view of the individual components of one embodiment of the sign exhibiting kit of the present invention.

FIG. 2 illustrates a perspective view of the various frame components in spatial relationship to one another.

FIG. 2A illustrates a close-up view of one embodiment of the frame member mounting bracket.

FIG. 2B illustrates a close-up perspective view of one embodiment of a frame member end.

FIG. 3 illustrates a perspective view of the completed sign installed on an easel.

FIG. 4 illustrates a perspective view of the completed sign installed on a wall.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details.

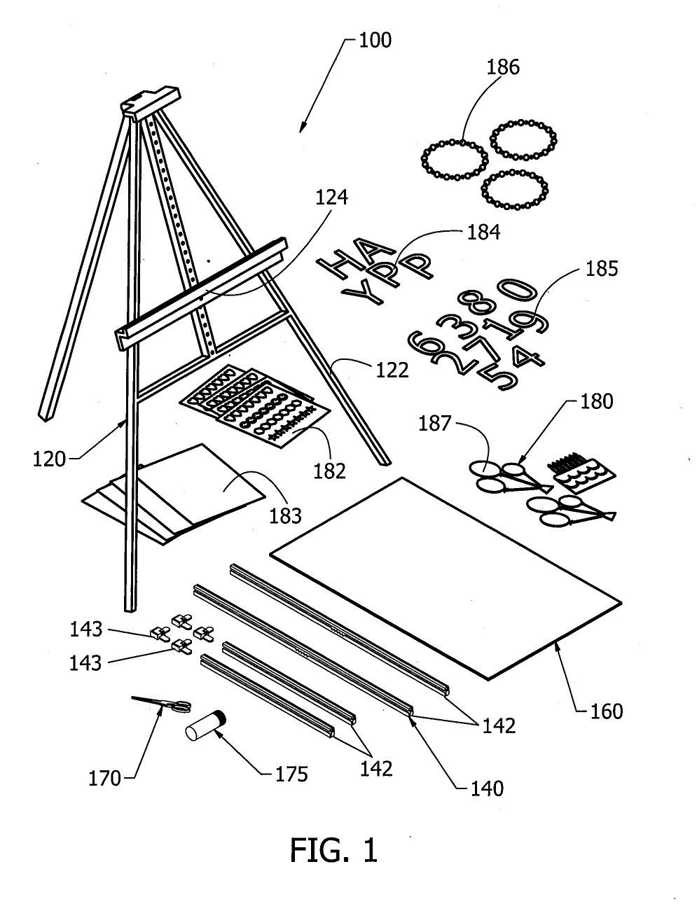

Referring initially to the drawings, FIG. 1 illustrates one embodiment of the sign exhibiting kit 100 of the present invention which is preferably comprised of an easel 120, a constructible frame 140, a media 160, scissors 170, glue 175, and at least one accessory 180 for creating a sign or exhibit 200 on said media 160. Easel 120 can be any easel commonly known in the art and readily available in most art or craft stores, and is typically comprised of a plurality of legs 122 and media retaining members 124, as is illustrated in FIG. 1. As is commonly known in the art, media retaining members 124 are preferably adjustable to accommodate and retain media 160 of various shapes and sizes. As is also commonly known in the art, easel 120 is preferably collapsible so that the same is relatively easy to transport, set-up and store. Easel 120 can be comprised of wood, plastic, metal or any other durable material, and is preferably between 18 and 48 inches in height, though it is contemplated that other sized easels 120 could also be used.

Constructible frame 140 is preferably comprised of a plurality of frame members 142 and corners 143 that can be removably attached to one another and to media 160 to form a frame or border around media 160, or a portion thereof, to enhance the aesthetics of the sign 200, as is further described below. For example, frame members 142 and corners 143 can be attached to one another by any common means known in the art including, without limitation, tongue/groove, snap connection, male/female receptors, hook and loop fasteners, glue, etc. Alternatively, it is also contemplated that each frame member 142, with or without corners 143, can be attached to media 160 and adjacent, but not attached, to other frame members 142 or corners 143 such that, collectively, the frame members 142, and possibly the corners 413, give the appearance that they form a single constructible frame 140.

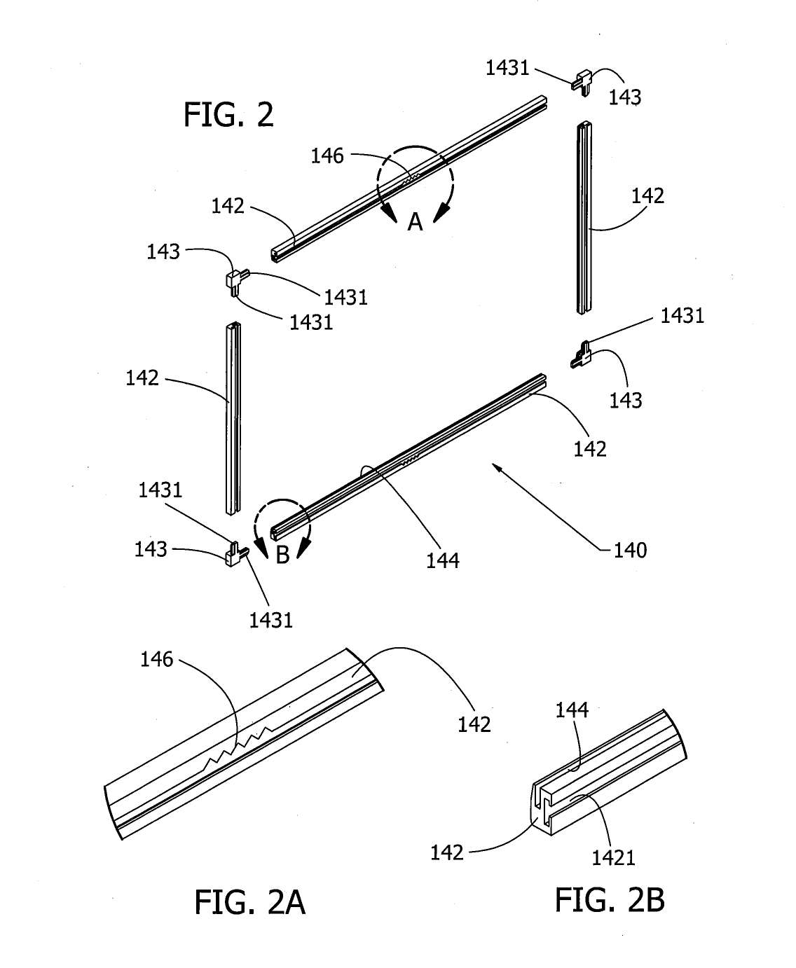

Frame members 142 and corners 143 can come in a variety of shapes, sizes and colors, and are preferably constructed of decorative or ornamental wood or plastic, though it is contemplated that other materials, such as aluminum or other metals, could also be used without affecting the overall concept of the present invention. FIG. 2 depicts a preferred embodiment of the constructible frame 140 of the present invention in which the plurality of frame members 142 are generally elongated members with an opening 1421 therein. In this particular embodiment, which is not meant to be a limitation, corners 143 further comprise male members 1431 for insertion into opening 1421 in frame member 142, thereby enabling a user (not shown) to easily and securely connect frame members 142 and corners 143 to form constructible frame 140. As previously mentioned, alternative methods of connecting frame members 142 and corners 143 to each other, or to media 160, are also contemplated.

In a preferred embodiment of the present invention, frame members 142 are further comprised of a channel 144 formed therein for receipt of media 160, as is best shown in FIG. 2B. Alternatively, frame members 142, with or without corners 143, may be attached to media 160 by an means known in the art including, without limitation, with glue 175.

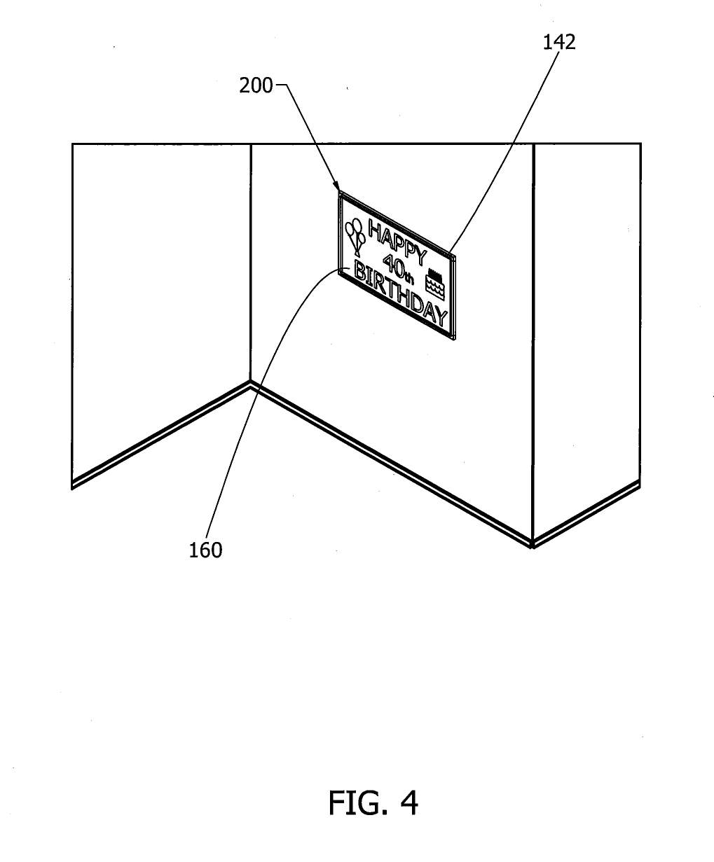

One or more frame members 142 may further comprise a mounting bracket 146, for attaching said constructible frame 140 to a wall or other structure as shown in FIG. 4. As depicted in FIG. 2A, mounting bracket 146 can be formed in frame member 142, or can be any other mounting bracket commonly known in the art for exhibiting or hanging a framed picture or painting on a vertical surface. A sufficient quantity of frame members 142 and corners 143 should be included within kit 100 to enable the user (not shown) to adorn the perimeter of media 160 with constructible frame 140.

Media 160 is preferably comprised of poster board, paper, cardstock, construction paper, cardboard or any other known material suitable for creating sign 200 to display a message. Media 160 can be included within kit 100 in a variety of colors, shapes and/or sizes to afford the user (not shown) a wide variety of options for creating sign 200. It is contemplated that media 160 can serve as the base or foundation of sign 200, and/or media 160 could be cut into smaller decorative shapes and designs with scissors 170, which could also be included within kit 100, and attached to base media 160 with any known adhesive such as, without limitation, glue 175.

A number of accessories 180 can also be included in kit 100 to afford the user (not shown) a wide variety of options for creating sign 200. For example, accessories 180 could include one or more of the following commonly known and readily available items: stickers 182, paper 183, letters 184, numbers 185, charms 186 or themed decorations 187. Accessories 180 are preferably self adhesive so that the same can be readily attached to sign 200, media 160 and/or constructible frame 140. Alternatively, accessories 180 may be attached to sign 200, media 160 and/or constructible frame 140 in any matter commonly known in the art including, without limitation, with glue 175. It is also contemplated that accessories 180 could further comprise one or more writing utensils (not shown) such as markers, crayons, pens, pencils, and the like.

Having now described the preferred embodiment of kit 100, its use and usefulness will now be described. A user (not shown) desiring to create and exhibit a sign 200 could acquire kit 100, which is preferably comprised of an easel 120, a constructible frame 140, a media 160, scissors 170, glue 175, and at least one accessory 180. Further, the accessories 180 could comprise one or more of the following: stickers 182, paper 183, letters 184, numbers 185, charms 186 or themed decorations 187. For example, kit 100 could be directed to a sporting event and themed decorations 187 could be comprised of a particular sport or team's colors, logos, players and the like. Alternatively, kit 100 could be directed to a birthday celebration, and themed decorations 187 could comprise birthday wishes, age denomination, candles, cakes and the like. Other kits 100 could be directed to other special occasions including, without limitation, promotions, anniversaries, graduation, births, engagements, weddings, memorials, etc. Still other kits 100 could be themed with items of cultural significance including, without limitation, superheroes, cartoon characters, personalities, etc. The possibilities are endless and examples contained herein should not be construed as limitations.

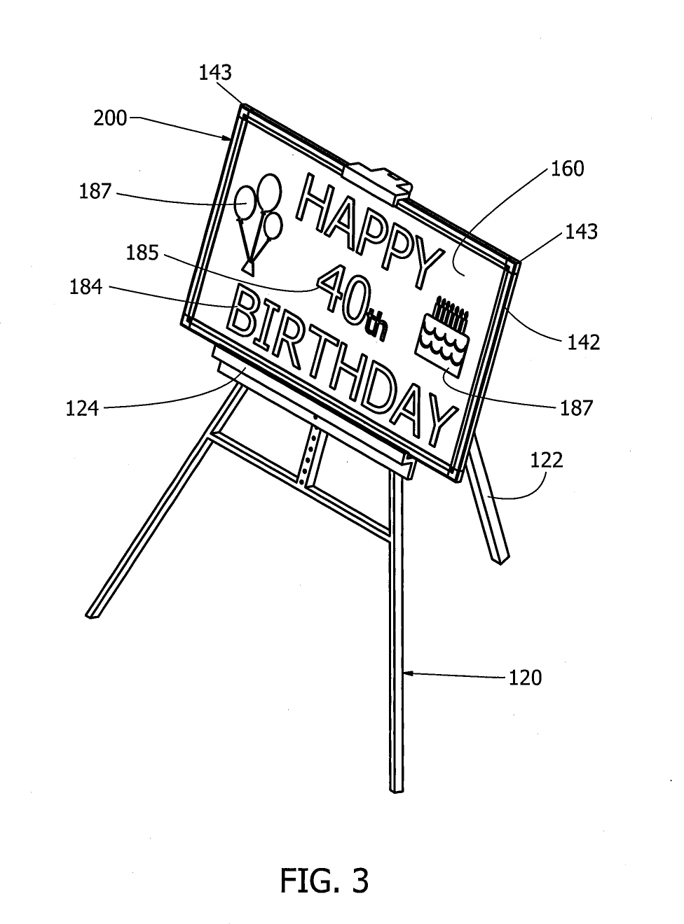

Once the appropriate kit 100 has been acquired, user (not shown) can go about creating sign 200 using the contents of kit 100 and the user's own creativity and imagination. Further, once sign 200 has been created, the user can use frame members 142 to create a constructible frame 140 for attachment to sign 200. Framed sign 200 can then be readily displayed on easel 120, as is commonly known in the art and depicted in FIG. 3, or hung on a wall or other structure via the use of mounting bracket 146, as previously discussed and depicted in FIG. 4.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A sign exhibiting kit comprising:
an easel;
a constructible frame;
a media; and
at least one accessory for creating a sign.

2. The sign exhibiting kit of claim 1 wherein said at least one accessory for creating a sign is selected from one of the following: stickers, paper, letters, numbers, charms, writing utensil or themed decorations.

3. The sign exhibiting kit of claim 1 wherein said media is comprised of at least one of the following: poster board, paper, cardstock, construction paper, or cardboard.

4. The sign exhibiting kit of claim 1 wherein said easel is adjustable and collapsible.

5. The sign exhibiting kit of claim 1 wherein said constructible frame is further comprised of a plurality of frame members that are attachable to said media.

6. The sign exhibiting kit of claim 5 wherein at least one of said plurality of frame members further comprises at least one mounting bracket.

7. The sign exhibiting kit of claim 1 further comprising a pair of scissors and an adhesive.

8. A sign exhibiting kit comprising:
an easel;
a media;
a constructible frame for attachment to said media, wherein said constructible frame is comprised of a plurality of frame members and a plurality of corners; and
a themed decoration.

9. The sign exhibiting kit of claim 8 further comprising at least one accessory, wherein said at least one accessory is selected from one of the following: stickers, paper, letters, numbers, writing utensils, charms, or themed decorations.

10. The sign exhibiting kit of claim 8 wherein said media is comprised of at least one of the following: poster board, paper, cardstock, construction paper, or cardboard.

11. The sign exhibiting kit of claim 8 wherein said easel is adjustable and collapsible.

12. The sign exhibiting kit of claim 8 further comprising a pair of scissors and an adhesive.

13. The sign exhibiting kit of claim 8 wherein said at least one of said plurality of frame members further comprises at least one mounting bracket.

14. The sign exhibiting kit of claim 8 wherein at least one of said plurality of frame members is further comprised of a channel.

15. A sign exhibiting kit comprising:
an easel;
a constructible frame;
a media;
a pair of scissors;
an adhesive;
at least one sticker;
at least one number;
at least one letter;
at least one writing utensil;
at least one charm; and
a themed decoration.

16. The sign exhibiting kit of claim 15 wherein said easel is adjustable and collapsible.

17. The sign exhibiting kit of claim 15 wherein said constructible frame is attachable to said media.

18. The sign exhibiting kit of claim 15 wherein said constructible frame further comprises more than one frame member.

19. The sign exhibiting kit of claim 18 wherein at least one of said more than one frame members further comprises at least one mounting bracket.

20. The sign exhibiting kit of claim 15 wherein said media is further comprised of at least one of the following: poster board, paper, cardstock, construction paper, or cardboard.
